(19) United States
(12) Patent Application Publication
(10) Pub. No.: US 2003/0050789 A1
(43) Pub. Date: Mar. 13, 2003

(54) Method and apparatus for monitoring execution of a business process managed using a state machine

(75) Inventors: Laurent David Hasson, New York, NY (US); John Scott Houston, Hopewell Junction, NY (US)

Correspondence Address: Ryan, Mason & Lewis, LLP, 1300 Post Road, Suite 205, Fairfield, CT, 06430, US

(73) Assignee: International Business Machines Corporation, Armonk, NY

(21) Appl. No.: 09/951,025

(22) Filed: Sep. 12, 2001

(51) Int. Cl. G06F 17/60

(52) U.S. Cl. 705/1

(57) ABSTRACT

A state-based method and apparatus are disclosed for tracing and auditing a business process managed using a state machine. The disclosed system can selectively vary the tracing and auditing based, for example, upon the specific state within the business process or the identity of the organization or user associated with a given transaction. An organization can indicate whether any trace or audit information (or both) should be collected for the organization. In addition, the specific information that is collected for a given state in the state machine can be separately specified for a trace mode or audit mode. Trace and audit records can be tailored to the organization and situation at hand. The collected trace and audit information reflect the values associated with the object at well-defined points in time since they are associated with the states of the business process.

### CROSS REFERENCE TO RELATED APPLICATIONS

The present invention is related to United States Patent Application entitled “Method and Apparatus for Automatic Transitioning Between States in a State Machine That Manages a Business Process,” (Attorney Docket Number SOM920010005US1), United States Patent Application entitled “Method and Apparatus for Managing The Versioning of Business Objects Using a State Machine,”(Attorney Docket Number SOM920010006US1), United States Patent Application entitled “Method and Apparatus for Creating and Managing Complex Business Processes,”(Attorney Docket Number SOM920010007US1), United States Patent Application entitled “Method and Apparatus for Managing and Displaying User Authorizations for a Business Process Managed Using a State Machine,”(Attorney Docket Number SOM920010009US1) and United States Patent Application entitled “Method and Apparatus for Managing a User Group List For a Business Process Managed Using a State Machine,”(Attorney Docket Number SOM9200100010US1), filed contemporaneously herewith, assigned to the assignee of the present invention and incorporated by reference herein.

### FIELD OF THE INVENTION

The present invention relates generally to techniques for representing business processes as state machines, and more particularly, to a method and apparatus for monitoring the execution of a business process that is managed using a state machine.

### BACKGROUND OF THE INVENTION

The execution of a complex business process, such as a transaction server for an e-commerce application, must often be monitored to identify the source of errors or inefficient performance and to develop an audit trail. A number of debugging tools have been developed that monitor the execution of a software program and generate a trace file that may be analyzed to determine the source of errors or inefficient performance. For example, various analysis tools exist that allow a programmer to insert debugging code into specific portions of a software program that will create an entry in a trace file each time the inserted portions of the code are executed.

Similarly, a number of auditing tools have been developed that monitor the execution of a software program and generate an audit trail to document, for example, the identity of individuals who performed certain tasks. Various auditing tools exist that generate an entry in an audit file each time certain tasks are performed. The audit file entries may identify, for example, the time of the task and the individual associated with the task.

The requirements for tracing and auditing interactions typically differ from one organization to another, or even from one user to another user of the same system. The tracing and auditing requirements may depend, for example, on the needs of the organization, the processes being monitored and the needs of the software and services organizations to resolve problems experienced by a web site and by its users. For example, different users may encounter different problems or the same problem in a different way while performing the same transaction. Therefore, it may be desirable for a trace tool to collect user-specific information in order to identify and resolve these problems. Similarly, with regard to collected audit information, some organizations may be required by law (or their own business needs) to retain detailed audit trails that indicate who performed each action during some transaction. Meanwhile, another organization, using the same business process, may only need minimal audit trails for activities related to certain transactions, such as those exceeding a certain dollar amount.

A need therefore exists for an improved method and apparatus for monitoring the execution of a business process. Yet another need exists for a software monitoring tool that minimizes the impact on the overall performance of the business system. In addition, a further need exists for a software monitoring tool that provides a state-based tracing and auditing system that may be varied based upon the specific state within the business process, as well as the identity of the organization or user associated with a given transaction.

### SUMMARY OF THE INVENTION

Generally, a state-based method and apparatus are disclosed for tracing and auditing a business process managed using a state machine. The disclosed system can selectively vary the tracing and auditing based, for example, upon the specific state within the business process or the identity of the organization or user associated with a given transaction. In one exemplary implementation, flags can be defined for an organization to indicate whether any trace and audit information should be collected for the organization. Similarly, the specific information that is collected for a given state in the state machine can be separately specified for a trace mode or audit mode.

The present invention allows trace and audit records to be tailored to the organization and situation at hand. In addition, the collected trace and audit information reflect the values associated with the object at well-defined points in time since they are associated with the states of the business process.

A more complete understanding of the present invention, as well as further features and advantages of the present invention, will be obtained by reference to the following detailed description and drawings.

### BRIEF DESCRIPTION OF THE DRAWINGS

FIG. 1 illustrates an exemplary conventional state machine having two states for managing a business process;

FIG. 2 is a sample table from an exemplary flow state dictionary table;

FIG. 3 is a sample table from an exemplary membership trace and audit table;

FIG. 4 illustrates an exemplary state machine for managing an order process in accordance with the present invention; and

FIG. 5 illustrates an exemplary network environment in which the present invention can operate.

### DETAILED DESCRIPTION OF PREFERRED EMBODIMENTS

The present invention provides a state-based method and apparatus for tracing and auditing a business process that is managed using a state machine. The disclosed system can vary the tracing and auditing based, e.g., upon the specific state within the business process or the identity of the organization or user associated with a given transaction.

### State Machine Terminology

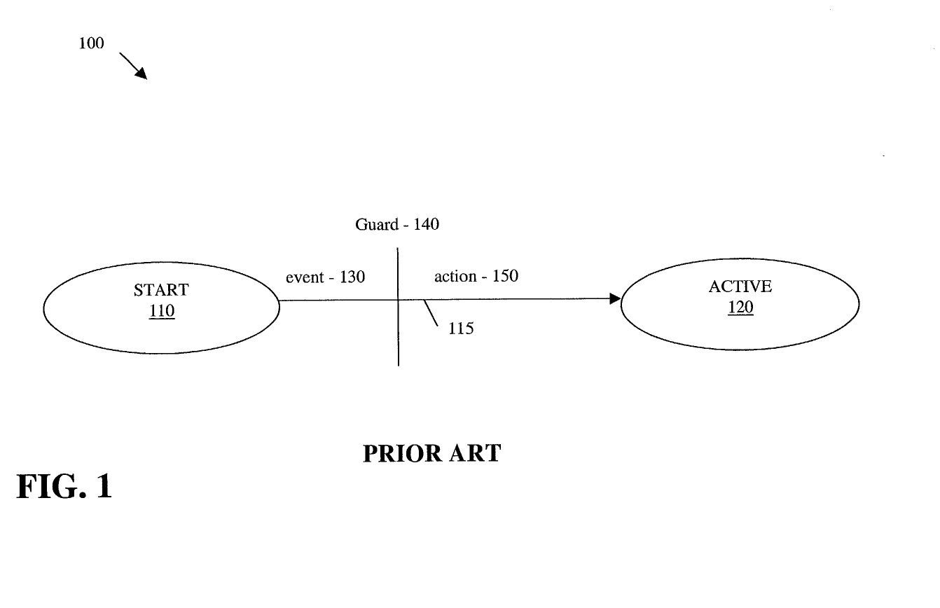

Business processes can be represented using a state machine. State machines provide a way to control the set of events and actions that may be performed throughout the life cycle of a business object. The Unified Modeling Language (UML) provides a standardized syntax for describing state machines. FIG. 1 illustrates an exemplary state machine 100 having two states 110, 120 with a single transition 115 leading from the Start state 110 to the Active state 120. The transition 115 is composed of three parts. First, there is an event 130 that defines what may cause this transition 115 to be attempted. Second, one or more guards 140 determine whether or not the transition 115 may be taken based upon some predefined criteria, such as the authority of the user or certain values associated with the business object. Finally, the action 150 provides a means for identifying logic that may act upon, or on behalf of, the object being managed by the state machine 100. Thus, if the transition 115 is allowed according to the guards 140, then the action 150 is performed and the object moves into the Active state 120. The various components of a transition 115 can be expressed using the notation “event [guard] action.”

For a more detailed discussion of techniques for managing business processes using a state machine, see, for example, U.S. patent application Ser. No. 09/818,719, filed Mar. 27, 2001, entitled “E-Market Architecture for Supporting Multiple Roles and Reconfigurable Business Processes,” August-Wilhelm Scheer, Aris—Business Process Modeling, Springer Verlag, 1999 or Peter Muth et al., Enterprise-Wide Workflow Management Based on State and Activity Charts, in A. Dogac, L. Kalinichenko, T. Ozsu, A. Sheth (Editors), Workflow Management Systems and Interoperability, Springer Verlag, 1998, each incorporated by reference herein.

Consider two exemplary businesses that participate in an online business-to-business marketplace, such as the XYZ Corporation and LMNOP Company. The business process that they each use for managing an auction may be virtually identical, so they both choose the same business process from those available at a web site. However, due to differences in the corporate structure of each company, their needs for audit trails may be extremely different. The XYZ Corporation, a public corporation, may need to record every decision made about every transaction. On the other hand, the LMNOP Company is a small privately-owned business and only needs to save information required for tax purposes. Thus, the audit trail needs of the LMNOP Company are significantly different from the needs of the XYZ Corporation.

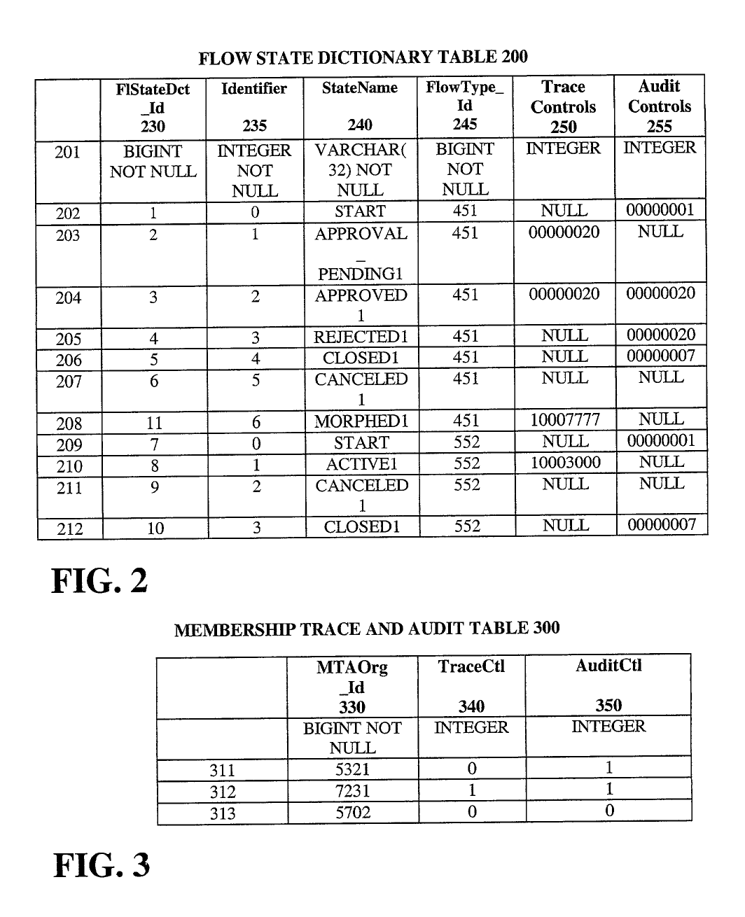

When a state machine is used to manage business processes, information about each state may be saved in a database table, such as the flow state dictionary table 200 shown in FIG. 2. The flow state dictionary table 200 includes a plurality of records, such as records 201-212, each associated with a different state in the state machine. For each state identified in field 230, the flow state dictionary table 200 stores, among other things, an identifier in field 235 that uniquely identifies the state within a Flow Type, the name of the states in field 240, the flow type to which the state belongs in field 245, and trace and audit controls in fields 250 and 255, respectively. The value of the trace and audit fields 250, 255 may indicate the type of information which must be saved in the trace or audit records. A value of NULL indicates that there is no trace or audit data to be saved with respect to this state.

FIG. 3 is a sample table from an exemplary membership trace and audit table 300. Generally, the membership trace and audit table 300 that records organization-based trace and audit controls. As shown in FIG. 3, the membership trace and audit table 300 has a plurality of records, such as records 311-313, each associated with a different organization. For each organization identified in field 330, the membership trace and audit table 300 indicates whether trace and audit information should be collected in fields 340 and 350, respectively. For example, a binary value of one might indicate that the corresponding information should be collected. Thus, the organization associated with record 312 records both auditing and trace information, while the organization associated with record 311 records only auditing information.

Thus, the values stored in fields 340 and 350 of the membership trace and audit table 300 will determine whether any trace and audit information, respectively, should be collected for the organization, and the values stored in fields 250 and 255 of the flow state dictionary table 200 will identify the nature of the trace and audit information, respectively, that should be collected. For example, 00000020 for the trace controls, as recorded in field 201 may indicate that the user identifier who invoked the transition should be collected when the trace mode is activated by an organization.

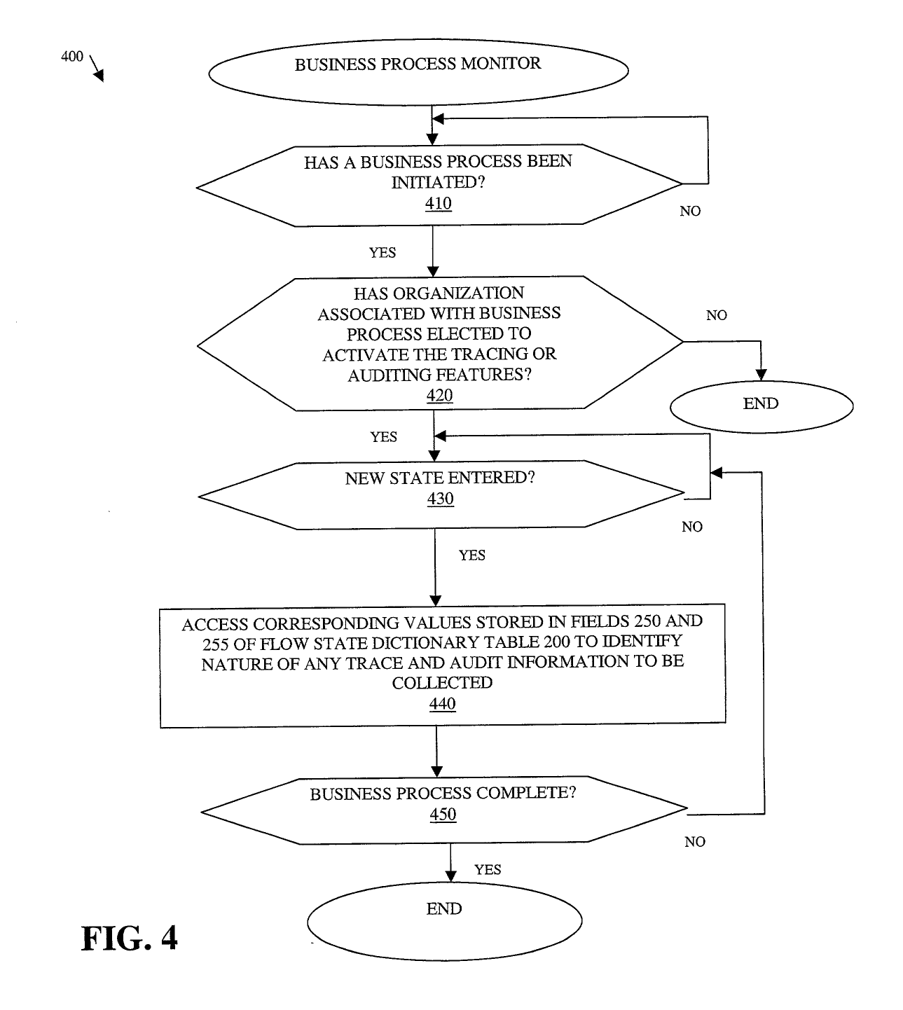

FIG. 4 is a flow chart describing an exemplary business process monitor 400. As shown in FIG. 4, the business process monitoring process 400 is initiated during step 410 in conjunction with the initiation of a business process. A test is performed during step 420 to determine if the organization associated with the business process has elected to activate the tracing or auditing features of the present invention (by accessing the values stored in fields 340 and 350 of the membership trace and audit table 300). If it determined during step 420 that the organization has elected not to activate the tracing or auditing features of the present invention, then program control terminates while the business process continues executing in a conventional manner.

If, however, it is determined during step 420 that the organization has elected to activate the tracing or auditing features of the present invention, then as the business process progresses through the entry object of each state, the corresponding values stored in fields 250 and 255 of the flow state dictionary table 200 are accessed during step 440 to identify the nature of any trace and audit information, respectively, that should be collected. Once the business process is complete, the business process monitoring process 400 will also terminate.

In placing control of the tracing and auditing under the control of the business process manager, performance gains can be made by not checking the criteria everywhere throughout the commands. The trace and audit records can be tailored to save only the information required for the situation at hand, and the trace and audit information reflect the values associated with the object at well-defined points in time since they are associated with the states of the process. The advantages of these features are significant and well beyond the current art in regard to trace and audit controls.

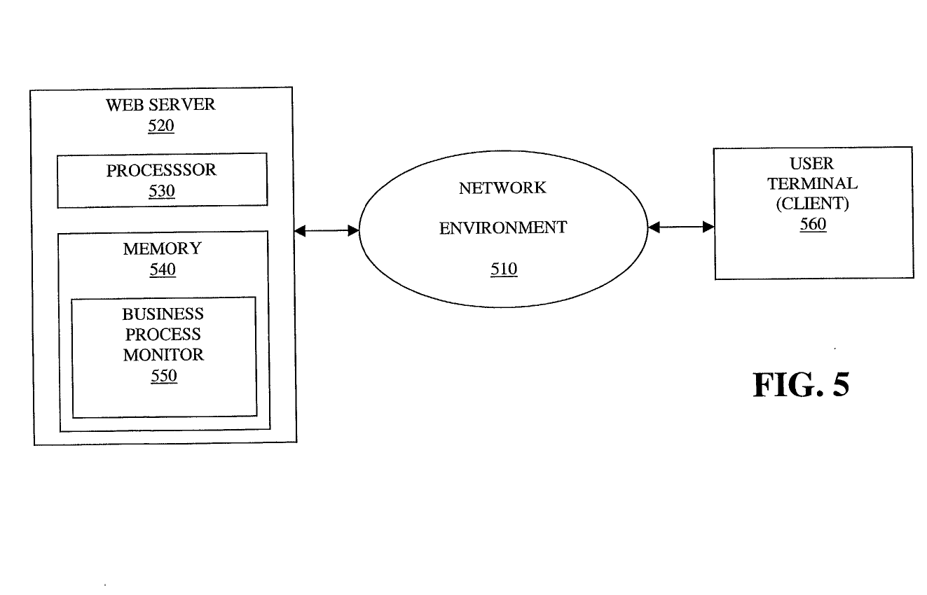

FIG. 5 illustrates an exemplary network environment 510 in which the present invention can operate. As shown in FIG. 5, a web server 520 communicates over a network 510 with a user terminal 560. For example, the user 560 may submit an order for goods or services to the web server 520. The transaction may be monitored in accordance with a business process monitor 550 incorporating features of the present invention, as discussed above in conjunction with FIG. 4. The network 510 can be any wired or wireless network for transferring information, such as a data network or a telephone network.

Memory 540 will configure the processor 530 to implement the methods, steps, and functions disclosed herein. The memory 540 could be distributed or local and processor 530 could be distributed or singular. The memory 540 could be implemented as an electrical, magnetic or optical memory, or any combination of these or other types of storage devices. The term “memory” should be construed broadly enough to encompass any information able to be read from or written to an address in the addressable space accessed by processor 530. With this definition, information on a network 510 is still within memory 540 of the web server 520 because the processor 530 can retrieve the information from the network 510.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

It is to be understood that the embodiments and variations shown and described herein are merely illustrative of the principles of this invention and that various modifications may be implemented by those skilled in the art without departing from the scope and spirit of the invention.

What is claimed is:

1. A method for monitoring a business process using a state machine, said state machine having a plurality of states, at least one of said states including an entry action, said entry action including logic executed upon entering said state, said method comprising the step of:
providing monitoring logic in said entry action, said entry action causing information to be captured.

2. The method of claim 1, wherein said captured information is tracing information about the execution of said business process.

3. The method of claim 1, wherein said captured information is auditing information about a transaction associated with said business process.

4. The method of claim 1, wherein said captured information is recorded in a file for off-line analysis.

5. The method of claim 1, wherein said entry action allows said information to be selectively captured.

6. The method of claim 1, wherein said entry action may be configured by a user to allow said information to be captured in a desired manner.

7. A method for managing a business process using a state machine, said state machine having a plurality of states, at least one of said states including an entry action, said entry action including logic executed upon entering said state, said method comprising the steps of:
evaluating said entry action each time said state is entered, said entry action including selective logic to cause information to be captured; and
capturing said information if said selective logic is activated.

8. The method of claim 7, wherein said selective logic is a flag in a field which may be activated by an organization.

9. The method of claim 7, wherein said captured information is tracing information about the execution of said business process.

10. The method of claim 7, wherein said captured information is auditing information about a transaction associated with said business process.

11. The method of claim 7, wherein said captured information is recorded in a file for off-line analysis.

12. A system for monitoring a business process using a state machine, said state machine having a plurality of states, at least one of said states including an entry action, said entry action including logic executed upon entering said state, comprising:
a memory that stores computer-readable code; and
a processor operatively coupled to said memory, said processor configured to implement said computer-readable code, said computer-readable code configured to:
provide monitoring logic in said entry action, said entry action causing information to be captured.

13. The system of claim 12, wherein said captured information is tracing information about the execution of said business process.

14. The system of claim 12, wherein said captured information is auditing information about a transaction associated with said business process.

15. The system of claim 12, wherein said captured information is recorded in a file for off-line analysis.

16. The system of claim 12, wherein said entry action allows said information to be selectively captured.

17. The system of claim 12, wherein said entry action may be configured by a user to allow said information to be captured in a desired manner.

18. A system for monitoring a business process using a state machine, said state machine having a plurality of states, at least one of said states including an entry action, said entry action including logic executed upon entering said state, comprising:
a memory that stores computer-readable code; and
a processor operatively coupled to said memory, said processor configured to implement said computer-readable code, said computer-readable code configured to:
evaluate said entry action each time said state is entered, said entry action including selective logic to cause information to be captured; and
capture said information if said selective logic is activated.

19. An article of manufacture for monitoring a business process using a state machine, said state machine having a plurality of states, at least one of said states including an entry action, said entry action including logic executed upon entering said state, comprising:
a computer readable medium having computer readable code means embodied thereon, said computer readable program code means comprising:
a step to provide monitoring logic in said entry action, said entry action causing information to be captured.

20. An article of manufacture for monitoring a business process using a state machine, said state machine having a plurality of states, at least one of said states including an entry action, said entry action including logic executed upon entering said state, comprising:
a computer readable medium having computer readable code means embodied thereon, said computer readable program code means comprising:
a step to evaluate said entry action each time said state is entered, said entry action including selective logic to cause information to be captured; and
a step to capture said information if said selective logic is activated.
